(19) United States
(12) Patent Application Publication
(10) Pub. No.: US 2013/0060424 A1
(43) Pub. Date: Mar. 7, 2013

(54) STEERING ARRANGEMENT FOR A VEHICLE WHICH IS MOVABLE ALONG A PREDEFINED PATH IN USE, BEING AUTOMATICALLY STEERED VIA AT LEAST ONE FIRST AXLE, AS WELL AS A VEHICLE PROVIDED WITH SUCH A STEERING ARRANGEMENT

(71) Applicants: Rudolf Mathijs Jozef Bouwman, Hamont (BE); Jean Luc Valk, Eindhoven (NL)

(72) Inventors: Rudolf Mathijs Jozef Bouwman, Hamont (BE); Jean Luc Valk, Eindhoven (NL)

(73) Assignee: ADVANCED PUBLIC TRANSPORT SYSTEMS B.V., Helmond (NL)

(21) Appl. No.: 13/394,991

(22) PCT Filed: Sep. 13, 2010
(86) PCT No.: PCT/NL10/50578

§ 371 Date: Apr. 16, 2012

(30) Foreign Application Priority Data
Sep. 11, 2009 (NL) 1037276

(51) Int. Cl. B62D 6/00

(52) U.S. Cl. 701/41

(57) ABSTRACT

A steering arrangement for a vehicle which is movable along a predefined path in use, being automatically steered via at least one first axle. Also disclosed is a vehicle provided with such a steering arrangement. Further disclosed is a method for moving a vehicle that is automatically steered via at least one first axle by a steering device along a predefined path. The steering arrangement is for use in an automatically guided and steered vehicle, i.e. without a driver, wherein the steering arrangement can continue to influence the steerage of the vehicle for a minimum period of time in case of a malfunction, such that the risk of dangerous situations or accidents is minimized.

### PRIORITY CLAIM

This patent application is a U.S. National Phase of International Patent Application No. PCT/NL2010/050578, filed 13 Sep. 2010, which claims priority to Dutch Patent Application No. 1037276, filed 11 Sep. 2009, the disclosures of which are incorporated herein by reference in their entirety.

### FIELD

One disclosed embodiment relates to a steering arrangement for a vehicle which is movable along a predefined path in use, being automatically steered via at least one first axle.

Another disclosed embodiment relates to a vehicle provided with such a steering arrangement.

Yet another disclosed embodiment relates to a method for moving a vehicle that is automatically steered along a predefined path by a steering device via at least one first axle.

### BACKGROUND

In public transport systems, and in particular in transport systems which make use of passenger buses, there is a continuous search for new developments that must make it possible, in particular in densely populated areas, to provide the public with a fast, comfortable and high-frequency public transport system.

A development that is frequently used already is the adaptation of the infrastructure, which involves the construction of special lanes intended only for public transport. This makes it possible to handle large passenger flows, in particular during the rush hours, with the means of public transport hardly, if at all, being impeded by other traffic flows.

At present there is an additional development is in progress, according to which the vehicle is guided and steered along a predefined path. The path generally consists of a lane specially reserved for this purpose within the infrastructure, which infrastructure may or may not exist yet, which lane is in principle closed to the other road users.

The guidance of such a guided and steered vehicle is realized, for example, by installing passive (for example, magnetic) markers in the road surface, which markers are detected by a path tracking system in the vehicle, on the basis of which the steering arrangement of the guided and steered vehicle may make adjustments as regards the direction to be followed and the vehicle speed. Instead of using markers in the road surface it is also possible to use other tracking systems, for example, reflectors and GPS. In use, the path tracking system will minimize a detected deviation of the vehicle from the predefined path as much as possible.

The safety of the passengers being transported in such an automatically guided and steered vehicle is an important point of consideration. Such a vehicle must, therefore, be provided with means for preventing dangerous situations that may occur in case of a malfunction in the steering arrangement. It is in particular desirable that the steering function of the steering arrangement (and consequently also the path tracking system) remain operational in case of a malfunction in the steering arrangement, for example, because part of the steering function is lost.

### SUMMARY

The disclosed embodiments provide a steering arrangement for use in a guided and steered vehicle, which steering arrangement can continue to influence the steerage of the vehicle for a minimum period of time, and independently of a driver who may be present, in case of a malfunction, such that the risk of dangerous situations or accidents is minimized.

### BRIEF DESCRIPTION OF THE DRAWINGS

The disclosed embodiments will now be explained in more detail with reference to the drawings, in which:

FIG. 1 shows a schematic illustration of an automatically guided and steered vehicle in a specific lane;

FIG. 2 shows a first embodiment of a steering arrangement for an automatically guided and steered vehicle; and

FIG. 3 shows a second embodiment of a steering arrangement for an automatically guided and steered vehicle.

### DETAILED DESCRIPTION

In order to further minimize undesirable deviation from the predefined path in case of a malfunction in the steering arrangement, for example, at high speeds, the steering arrangement comprises a path tracking system comprising information characteristics relating to the predefined path to be followed; path sensor means designed to detect a deviation from the predefined path by the vehicle; and steering means designed to steer the at least first axle to correct the detected deviation from the path. The steering means comprise at least three drivelines, which drivelines control the at least first axle independently of each other.

In case of failure of at least part of the steering arrangement due to a malfunction, the steering functionality will be retained, for example, for making timely steerage adjustments and being able to stop the vehicle within a very short period of time. In this way the vehicle is in any case prevented from deviating from its predefined path in an uncontrolled manner in case of a malfunction, in which case the vehicle will be steered by one of the other independently operating drivelines.

In this way, the functionality of the steering arrangement is guaranteed, in particular when the vehicle is moving at a higher speed, in which case an unacceptable deviation from the predefined path could lead to unacceptable, dangerous situations. Thus, quick and adequate action can be taken, making it possible to minimize a deviation from the predefined path of the vehicle, even at high speeds, and to stop the vehicle in time.

According to another disclosed embodiment of the steering arrangement, each driveline comprises a drive unit, which drive unit controls a driving motor that is coupled to the at least first axle via a transmission, while, according to another aspect, the driving motors of the drivelines differ from each other. More specifically, each of the driving motors is coupled to the transmission via a different transmission ratio.

By configuring the various drivelines with different parts, the risk of simultaneous failure of all the drivelines—for example, resulting from manufacturing defects if the same parts are used—is minimized. In this way a safe interference with the steering arrangement is realized, in particular, when the vehicle is moving at a high speed, in which case an unforeseen deviation from the predefined path can lead to unacceptable dangerous situations. By configuring the steering device as a triple steering device, the steering functionality will be retained in case of a malfunction and quick and adequate corrective action can be taken, making it possible to minimize a deviation from the predefined path of the vehicle, even at high speeds, and to stop the vehicle in time.

In another disclosed embodiment, the steering arrangement comprises further steering means designed to steer at least one further axle. In the case of this specific vehicle, the vehicle is to be provided not only with a first steerable axle but also with a further steerable axle.

In order to incorporate an additional safety aspect in the steerable axle, the further steering means comprise at least two further drivelines, which further drivelines control the at least one further axle independently of each other.

This prevents a situation in which the further axle is no longer being steered in case of a malfunction in the further steering means, since the drive and the steerage are directly taken over by the other driveline.

In yet another disclosed embodiment of the further steering means, the further drivelines control the at least one further axle independently of each other via a hydraulic piston/cylinder combination. The use of a hydraulic piston/cylinder combination provides a reliable and powerful control. More specifically, the hydraulic piston/cylinder combination is a double-acting piston/cylinder combination.

According to another disclosed embodiment of the steering arrangement, each further driveline controls a hydraulic valve, which valve is mounted in a hydraulic line that is in communication with the piston/cylinder combination.

In order to take over the control of the guided and steered vehicle in case of a malfunction in a part of the steering arrangement, and thus avoid dangerous situations and deviations from the predefined path, the steering arrangement comprises a guidance control system for controlling the steering means and/or the further steering means, which guidance control system more specifically controls the steering means and/or the further steering means via separate signal lines.

The steering arrangement comprises a redundant and error-tolerant communication bus to ensure a reliable control and signal processing to the further steering means also in the case of a malfunction in one of the communication buses. As a result, it will at all times be possible to activate one of the drivelines of the steering means and/or the further steering means via the still functioning part of the redundant communication bus, for example, for steering the vehicle such that a dangerous situation resulting from an unforeseen deviation from the path is eliminated or prevented as much as possible.

The guidance control system is in particular designed to stop the vehicle in case of a detected malfunction in the steering arrangement.

The method is used in an automatically steered vehicle which is moved along a predefined path by means of a steering arrangement, the method comprising the steps of detecting a deviation from the predefined path by the vehicle; correcting the detected deviation from the path by correctly controlling the steering arrangement connected to the at least first axle; and stopping the vehicle in case of a malfunction in the steering arrangement.

The method can also be used with a steering arrangement which is connected to a further steerable axle.

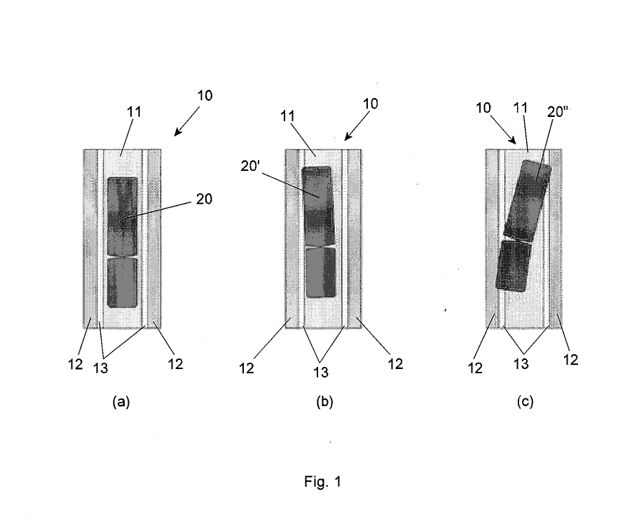

FIGS. 1a-1c are sketches showing the position of an automatically guided and steered vehicle 20 that follows a predefined path, being steered by a steering arrangement. The vehicle 20 is automatically guided and steered by means of a steering arrangement and can in principle be operated without a driver.

In a public transport system in which a vehicle 20 is automatically guided and steered by a steering arrangement supported by necessary control equipment, the path to be followed is usually a lane not intended for use by other road users, which lane is indicated at 10 in FIGS. 1a-1c. The lane is usually divided into a number of subsections 11-12-13, which are used by the path tracking system of the vehicle 20. Two lane sections 12 are defined on either side of the lane 10, between which lane sections the vehicle 20 is to move. The lane sections 12 can be regarded as forbidden areas for the vehicle 20, and consequently they are known as such to the path tracking system of the steering arrangement. Numeral 13 indicates an intermediate section, whilst the actual driving section is indicated at 11.

During normal operation of the path tracking system and the steering arrangement, the vehicle 20 can or is allowed to be present or move within the driving section 11 while normally following the predefined path.

FIG. 1a is indicated as a normal operating state, in which the vehicle 20 follows the predefined path in the driving section 11.

In general the steering arrangement of an automatically guided and steered vehicle 20 comprises a path tracking system in which information characteristics or way points of the path to be followed are stored. Such a path tracking system is usually provided with an image or a map on which the path to be followed is projected in the form of way points. In addition to that, the steering arrangement is provided with so-called path sensor means, which determine the position of the vehicle relative to the path to be followed while the automatically guided and steered vehicle 20 follows the predefined path in the driving section 11. The position detected by the path sensor means is used for determining a possible deviation from the path, on the basis of which necessary control signals for the steering means are generated for correcting the vehicle's deviation from the path.

A deviation from the path that is irresponsibly large is shown in FIG. 1b, in which the vehicle 20′, for reasons unknown, moves into the section 13, which deviation will be detected and subsequently be corrected by generating suitable corrective control signals to the steering arrangement and by carrying out a braking action on the wheels of the vehicle. In this way the vehicle's steerage will be continuously adjusted, so that the vehicle will follow the predefined path in the driving section 11.

FIG. 1c shows a situation in which the vehicle 20′, due to unforeseen circumstances, has deviated from the predefined path to such an extent that it leads to a dangerous traffic situation. Usually, such a situation develops upon failure of (part of) the steering arrangement, as a result of which the vehicle is no longer being guided, causing it to deviate from its predefined path.

If the speed of the vehicle 20′ is high at the moment of failure of the steerage, the deviation from the predefined path (the driving section 11) may be unacceptably large, which will inevitably lead to accidents. In such a situation it is desirable that the vehicle, which is no longer being guided in that case, be stopped as soon as possible.

The disclosed embodiments provide a solution in this regard, as the steering arrangement is provided with steering means designed to steer a first axle of the vehicle for the purpose of making corrections in the case of deviations from the path, which steering means comprise at least three drivelines, which drivelines control the first steerable axle independently of each other.

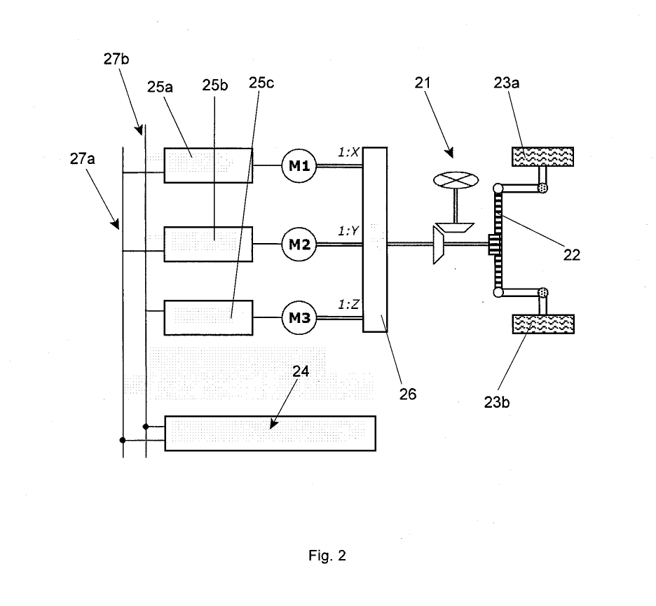

One disclosed embodiment of such a steering arrangement is shown in FIG. 2. In this figure the steering arrangement, indicated at 21, engages a first axle 22, which is in turn connected to two steerable wheels 23, 23b. For easy reference, the drawing does not include a further representation of the vehicle and/or the roadway.

The steering arrangement 21 comprises a guidance control system 24, to which measuring signals obtained from a path tracking system and route sensor means (not shown), which likewise form part of the steering arrangement 21, are supplied via signal lines 27a-27b. As already explained in the foregoing, the path tracking system is provided with information characteristics, in particular with way points forming a predefined path along which the vehicle 20 is to be moved.

The path sensor means are arranged for determining the position of the vehicle on the lane, for example, by means of (magnetic) passive markers installed in the road surface, or by means of GPS, on the basis of which a possible deviation of the vehicle from the predefined path is calculated. The data relating to speed, direction, engine speed etc are supplied to a guidance control unit 24 via the signal lines 27a-27b, which guidance control unit determines the position and the deviation from the path on the basis of the data and subsequently delivers suitable control signals to the steering arrangement 21.

The control signals may consist of corrective signals to adjust the direction of the vehicle 20 relative to the predefined path in the driving section 11.

If part of the steering arrangement fails due to unforeseen circumstances, the vehicle 20 is no longer being guided, which may lead to dangerous situations. Since a deviation can easily have disastrous consequences in particular at high vehicle speeds, it is desirable that the vehicle be stopped as soon as possible in such a precarious situation. On the other hand, it is also desirable in such a situation that the steering arrangement perform required corrective steering actions on the axle 22 to be steered while the vehicle is being stopped.

The latter is necessary because a passenger bus 20 will not come to an immediate standstill when driving at a high speed and because it must be possible in such a case to make steering adjustments yet. The steering arrangement 21 is to that end configured so that the steering means comprise at least three drivelines 25a-25b-25c, which drivelines 25a-25b-25c control the at least first axle 22 independently of each other. Each driveline comprises a drive unit 25a-25b-25c, which is controlled by the guidance control system 24 and which each control a driving motor M1-M2-M3.

The driving motors M1-M2-M3 are different from each other so as to minimize the risk of simultaneous failure due to manufacturing defects. Each driving motor M1-M2-M3 is moreover coupled to the transmission 26, using different transmission ratios 1:X, 1:Y and 1:Z, respectively, which transmission 26 is in turn connected to the first axle 22 to be steered.

In case an error in one of the drivelines 25a-25b-25c is detected by the guidance control system 24, the driveline in question will be disabled and an emergency procedure will be activated to stop the vehicle as soon as possible.

The guidance control system 24 of the steering arrangement can control the steering means 21, which are built up of the various drivelines, via separate, independent signal lines 27a-27b. The signal lines 27a-27b form a redundant and error-tolerant communication bus. The communication bus 27a controls the drivelines 25a and 25b, whilst the driveline 25c is controlled via the communication bus 27b. In case of a malfunction in a part of the multiple communication bus (for example, failure of the communication bus 27a), the guidance control system 24 will continue to control the driveline 25c via the still functioning communication bus 27b.

Furthermore, the guidance control system 24 will interfere in the brake system whilst simultaneously continuing to control the vehicle during braking, via at least one of the drivelines 25a-25b-25c that are active yet, such that the vehicle will follow the predefined path as much as possible.

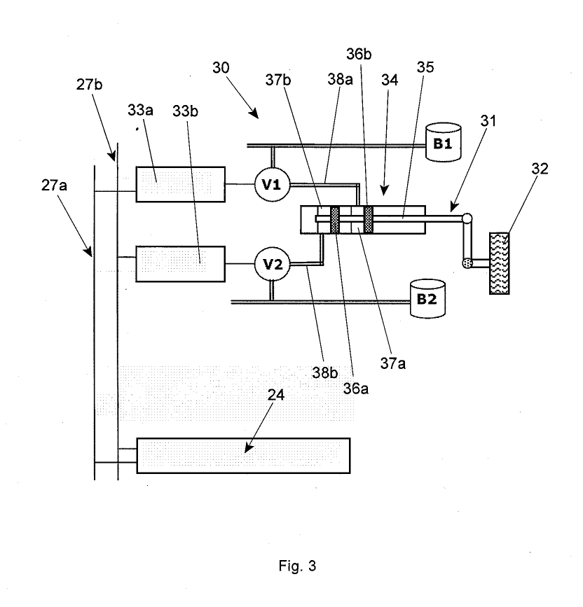

FIG. 3 shows an additional disclosed embodiment in which the steering arrangement comprises further steering means 30 designed to steer at least one further axle 31. The vehicle is not only provided with a first steering axle, therefore, but also with a further axle 31, which is also steerable. Thus, the vehicle being guided and steered along a predetermined path can also be steered by means of the further axle 31 and the wheels 32 connected thereto.

Using the further steering means 30, a path correction can be imposed on the vehicle by means of the additional steering axle 31. In an undesirable situation, a possible malfunction in the further steering means may lead to a potentially dangerous situation, in particular if the vehicle is moving at a high speed. The further steering means 30 are configured as twin steering means in this embodiment.

More specifically, the further steering means 30 are built up of two drivelines, indicated at 33a and 33b. The drivelines drive the at least one further axle 32 independently of each other. Each driveline comprises a drive unit 33a-33b, which drive units actuate a hydraulic piston/cylinder combination 34 independently of each other via servo valves V1 and V2, respectively, by means of which piston/cylinder combination the further axle 31 is steered. This prevents a situation in which the further axle is no longer being steered in case of a malfunction in the further steering means, since the drive and the steerage are immediately taken over by the other driveline.

Each trailing axle (i.e. not the front axle) comprises a (further) steering arrangement comprising two drivelines, so that the other driveline of a specific axle will keep the steering functionality intact in case of failure of one of the drivelines of a particular axle. The hydraulic piston/cylinder combination 34 is a double-acting piston/cylinder combination, which comprises a piston rod 35 that is connected to the further steering axle 31. In the cylinder, two pistons 36a-36b are mounted to the piston rod 35, which pistons divide the cylinder into two cylinder spaces 37a-37b. The cylinder space 37a is in communication with a buffer B1 for a hydraulic medium via a hydraulic line 38a and the servo valve V1. The servo valve V1, and thus the supply of hydraulic medium to the first cylinder space 37a via the line 38a, is controlled via the drive unit 33a of the first driveline. Likewise, the second cylinder space 37b is connected to a second buffer B2 for hydraulic medium via a hydraulic line 38b and the second servo valve V2.

The second servo valve V2 is controlled by the drive unit 33b. The two drive units 33a-33b are controlled by the guidance control system 24 via suitable signal lines 27a-27b. The signal lines 27a-27b form a redundant and error-tolerant communication bus. The communication bus 27a controls the driveline 33a, whilst the driveline 33b is controlled via the communication bus 27b. In case of a malfunction in a part of the multiple communication bus (for example, failure of the communication bus 27), the guidance control system 24 will continue to control the driveline 33b via the still functioning communication bus 27b.

In case of a malfunction, the remaining driveline 33b will thus be controlled in such a manner that suitable steering adjustments via the further steerable axle 31 can still be made also during braking of the vehicle, and consequently dangerous road situations can be avoided. By driving the further steering means by means of the guidance control system 24 via the redundant and error-tolerant communication bus 27a-27b, it is thus possible to stop the vehicle, during which stopping action controlled attempts will be made to keep the vehicle on the desired path by making steering adjustments.

The guidance control system 24 will to that end interfere with the brake system and, in addition to that, continue to steer the vehicle during braking via one of the still operative drivelines 33a-33b, in such a manner that the vehicle will follow the predefined path as much as possible.

Although the redundant and error-tolerant communication bus 27a-27b is represented in the form of control lines for controlling the various drivelines 25a-25c and 33a-33b in FIG. 2 (and FIG. 3), in an identical embodiment (not shown) the steering arrangement 24 comprises a redundant power source. The redundant supply source supplies power (voltage/current) to the various drivelines (and other parts of the steering arrangement) in a similar manner via various independent feed connections (or feeders).

Analogously, the guidance control system 24 will detect an unwished-for power cutoff to one of the drivelines and consequently it will control the steering device in an analogous manner as described above. The driveline in question will be disabled and the steering functionality will be retained. The vehicle will be stopped, and controlled attempts to keep the vehicle on the desired path by making steering adjustments will continue to be made.

1. A steering arrangement for a vehicle which is movable along a predefined path in use, being automatically steered via at least one first axle, the steering arrangement comprising:
a path tracking system comprising information characteristics relating to the predefined path to be followed;
path sensor means designed to detect a deviation from the predefined path by the vehicle;
steering means designed to steer the at least first axle so as to correct the detected deviation from the path, the steering means comprising at least three drivelines which control said at least first axle independently of each other.

2. The steering arrangement according to claim 1, wherein each driveline comprises a drive unit which controls a driving motor that is coupled to said at least first axle via a transmission.

3. The steering arrangement according to claim 2, wherein the driving motors of the drivelines differ from each other.

4. The steering arrangement according to claim 2, wherein each of said driving motors is coupled to the transmission via a different transmission ratio.

5. The steering arrangement according to claim 1, wherein the steering arrangement comprises further steering means designed to steer at least one further axle.

6. The steering arrangement according to claim 5, wherein said further steering means comprise at least two further drivelines which control said at least one further axle independently of each other.

7. The steering arrangement according to claim 6, wherein each further driveline comprises a drive unit coupled to said at least one further axle.

8. The steering arrangement according to claim 6, wherein said further drivelines control said at least one further axle independently of each other via a hydraulic piston/cylinder combination.

9. The steering arrangement according to claim 8, wherein said hydraulic piston/cylinder combination is a double-acting piston/cylinder combination.

10. The steering arrangement according to claim 8, wherein each further driveline controls a hydraulic valve which is mounted in a hydraulic line which is in communication with the piston/cylinder combination.

11. steering arrangement according to claim 1, wherein the steering arrangement comprises a guidance control system for controlling said steering means and/or said further steering means.

12. The steering arrangement according to claim 11, wherein said guidance control system controls said steering means and/or said further steering means via separate signal lines.

13. The steering arrangement according to claim 12, wherein the guidance control system comprises a redundant and error-tolerant communication bus.

14. The steering arrangement according to claim 5, wherein the guidance control system is designed so that the guidance control system will stop the vehicle upon detection of a malfunction in the steering arrangement.

15. An automatically steered vehicle provided with a steering arrangement according to claim 1.

16. A method for moving a vehicle that is automatically steered along a predefined path by a steering device via at least one first axle, wherein the steering arrangement comprises at least three drivelines, the method comprising:
detecting a deviation from the predefined path by the vehicle;
correcting the detected deviation from the path by correctly controlling the steering arrangement connected to said at least first axle;
stopping the vehicle in case of a malfunction in the steering arrangement.
